(19) United States
(12) Patent Application Publication
(10) Pub. No.: US 2006/0274281 A1
(43) Pub. Date: Dec. 7, 2006

(54) Projector having mechanism for reminding filter replacement

(75) Inventors: Fu Shiung Shih, Taichung County (TW); Sheng Chang Lu, Magong City (TW)

Correspondence Address: Attn: Juan Carlos A. Marquez;REED SMITH LLP, Suite 1400, 3110 Fairview Park Drive, Falls Church, VA, 22042, US

(73) Assignee: BenQ Corporation

(21) Appl. No.: 11/447,091

(22) Filed: Jun. 6, 2006

(30) Foreign Application Priority Data
Jun. 6, 2005 (TW) 94118636

(51) Int. Cl. G03B 21/16

(52) U.S. Cl. 353/60; 353/119

(57) ABSTRACT

A projector having a mechanism for alerting the need of filter replacement is provided. The projector comprises a housing, a filter, a first sensor, and a device. The first sensor is arranged inside the housing for measuring the temperature therein to obtain a first measurement value. When the first measurement value is greater than a predetermined value, the device transmits a signal for alerting a user to replace the filter.

### CROSS REFERENCE TO RELATED APPLICATIONS

This application claims priority to Taiwan Patent Application No. 94118636 entitled “Projector Having Mechanism For Reminding Filter Replacement”, filed on Jun. 6, 2005, which is incorporated herein by reference and assigned to the assignee herein.

### FIELD OF INVENTION

The present invention relates to a projector, and more particularly, to a projector having a mechanism for alerting the need of filter replacement.

### BACKGROUND OF THE INVENTION

How to displace the thermal energy produced by the light bulb during the use of a projector is one of factors for the projector to operate under normal condition.

Among the heat dissipation systems, there are designs that use air circulation to transfer the heat efficiently. The quality of the circulation air is one of factors affecting the dissipation efficiency. Therefore, typically before the air flows into the housing of the projector, a filtration operation is made to avoid negative impact on the projector by particles and soot in the air. The negative impact may result in insufficient heat dissipation causing high temperature within the projector, burn-out of the bulb, malfunction of projector and brightness deterioration of bulb.

Among the types of air filtrations, there are designs that provide filter at inlet of circulation air. Under this design, however, the users have to decide on their own the time to replace the filter when needed, usually based on experience or the estimated time elapsed since last installation of filter. Such approach does not actually reflect the condition of the filters which are either still usable or in deterioration conditions.

### SUMMARY OF THE INVENTION

A projector having a mechanism for alerting the need of filter replacement is provided in the invention.

An embodiment of the projector of the present invention comprises a housing, a filter, a first sensor and a device. The first sensor is arranged inside the housing for measuring the temperature therein to obtain a first measurement value. When the first measurement value is greater than a predetermined value, the device transmits a signal for alerting a user to replace the filter.

Another embodiment of the projector of the present invention comprises a housing, a filter, a first sensor, a second sensor and a device. The first sensor is arranged inside the housing for measuring the temperature therein to obtain a first measurement value. The second sensor measures the temperature outside the housing to obtain a second measurement value. When a difference between the first measurement value and the second measurement value is grater than a second predetermined value, the device transmits a signal for alerting the need of filter replacement.

### BRIEF DESCRIPTION OF THE DRAWINGS

FIG. 1 illustrates a projector in accordance with an embodiment of the present invention;

FIG. 2 illustrates a projector in accordance with another embodiment of the present invention;

FIG. 3 illustrates a projector in accordance with still another embodiment of the present invention; and

FIG. 4 illustrates a projector in accordance with still another embodiment of the present invention.

### DETAILED DESCRIPTION OF THE INVENTION

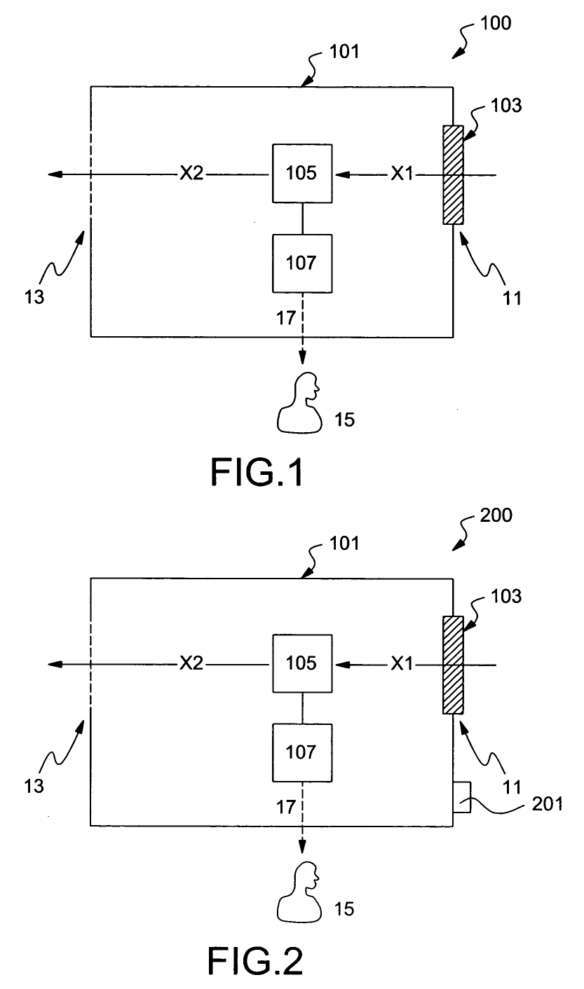

FIG. 1 illustrates a projector in accordance with an embodiment of the present invention. A projector 100 includes a housing 101, a filter 103 attached to the housing, a first sensor 105 arranged inside the housing 101, and a device 107. The filter 103 is used for filtering the air flowing into the interior space of the housing 101 to maintain quality of air therein. The first sensor 105 measures the temperature of the interior space to obtain a first measurement value. Afterwards, compare the first measurement value with a first predetermined value. If the first measurement value is grater than the first predetermined value, the device 107 transmits a signal 17 to a user 15 for altering the user 15 to replace the filter 103. The first measurement value is the temperature of the interior space of the housing 101, and the first predetermined value is the upper limitation below which the projector 100 operates normally. It means, whenever the temperature of the system reaches the upper limitation, the device 107 sends out a signal 17 to the user 15 alerting the user 15 to replace the filter 103. Generally, each critical element in the projector 100 is equipped with a mechanism for respective malfunction warning, therefore measured temperature raise within the interior space of the housing 101 indicates a certain degree of degeneration of the filter 103 has occurred and a replacement of the filter 103 is needed.

In FIG. 1, the first sensor 105 is arranged inside the housing 101 on path of the air flow. As shown in FIG. 1, driven by a fan (not shown), air enters the projector 100 through an inlet 11 and flows to the location of the first sensor 105 along direction X1. Thereafter, air fluxes out the projector 100 via an outlet 13 along direction X2. Since the first sensor 105 is arranged on path of the air flow, temperature variation inside the housing 101 can be reflected effectively. Whenever the variation of the temperature is beyond its tolerant limitation, the user 15 will be informed immediately for filter replacement to assure quality of air and ensure the dissipation efficiency.

Moreover, the first sensor 105 can also be located at a location in the projector 100 sensitive to the interior temperature variation, such as a location close to the light bulb, to monitor the temperature variation inside the housing 101 effectively and decide whether a replacement of the filter 103 is required.

FIG. 2 illustrates a projector in accordance with another embodiment of the present invention. A projector 200 includes a housing 101, a filter 103 attached to the housing 101, a first sensor 105 arranged inside the housing 101, a device 107, and a second sensor 201. The filter 103 is used for filtering the air flowing into the housing 101 to maintain quality of air therein. The first sensor 105 is used to measure the temperature of the interior space to obtain a first measurement value. The second sensor 201 measures the temperature outside the housing 101 to obtain a second measurement value. When a difference between the first measurement value and the second measurement value is greater than a second predetermined value, the device 107 transmits a signal 17 for alerting a user 15 to replace the filter 103. The first measurement value indicates the temperature inside the housing 101 and the second measurement value indicates the ambient temperature outside the housing 101. While a difference between the temperature of the interior space and that of the atmosphere is greater than the second predetermined value, the dissipation efficiency deteriorates because of a certain degree of flow congestion at the filter 103, and a replacement of the filter 103 is needed. As mentioned above, each critical element in the projector 200 is equipped with a mechanism for respective malfunction warning, therefore when the difference between the first measurement value and the second measurement value is greater than the first predetermined value, it means that the filtration efficiency is deteriorating to a certain level and a replacement of the filter 103 is required. More particularly, if other elements become invalid leading to a temperature raise, not only the device 107 will transmit a signal 17 to the user 15, the user 15 will also receive signal indicating corresponding failure component.

In FIG. 2, the first sensor 105 is similar to that described for FIG. 1. However, the example of FIG. 2 is different from the example of FIG. 1 since two sensors 105, 201 are in FIG. 2 and only one sensor 105 is in FIG. 1. And by detecting the temperature inside and outside, the two sensors reveal the filtration efficiency and indicate whether the filter 103 should be replaced.

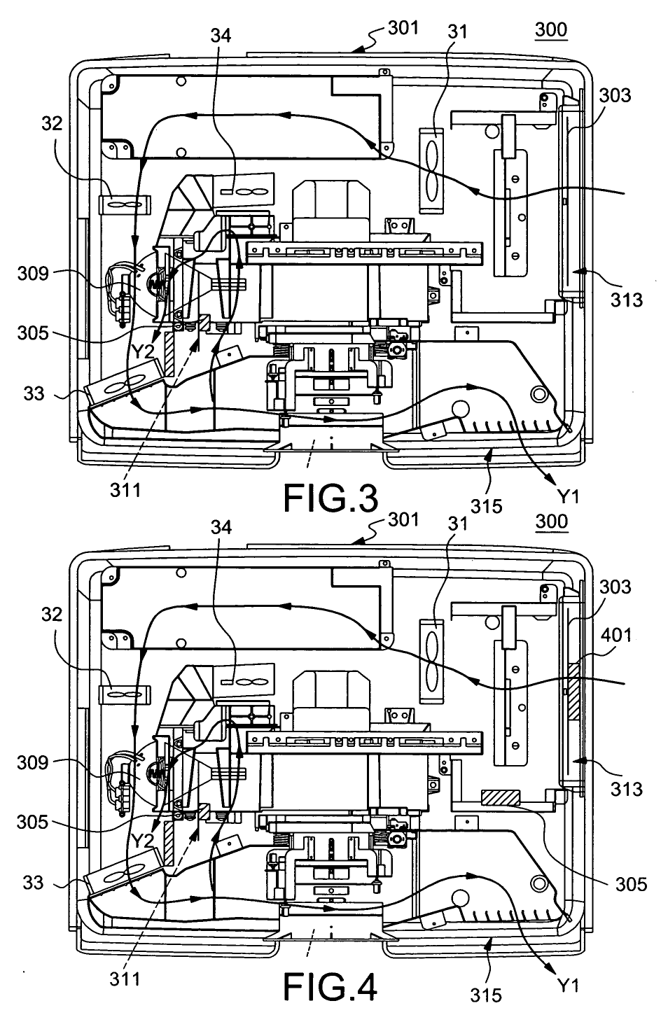

FIG. 3 illustrates a projector in accordance with still another embodiment of the present invention. A projector 300 includes a housing 301, a filter 303 attached to the housing 301, a first sensor 305 arranged inside the housing, a device (not shown), a light bulb 309, an optical element 311, and fans 31, 32, 33, and 34. Driven by fans 31, 32, 33, and 34, air flows in via an inlet 313 along direction Y1 and Y2 (Y2 is a circular design to increase dissipation efficiency of the light bulb 309) and passes through the light bulb 309 and the optical element 311, and then, fluxes out through an outlet 315. The filter 303 filters the air flowing into the housing 101 to assure quality of air therein. In the present example, the first sensor 305 is arranged on path of the air flow near the light bulb 309 for measuring the temperature inside the housing 301 to obtain a first measurement value. If the first measurement value is greater than a first predetermined value, the device (not shown) transmits a signal for alerting the user to replace the filter 303. As mentioned above, each critical element of the projector 300 is equipped with a mechanism for respective malfunction warning, therefore, measured temperature raise within the housing 301 indicates a certain degree of degeneration of the filter 303 and a replacement of the filter 303 is needed.

FIG. 4 illustrates a projector in accordance with still another embodiment of the present invention. A projector 300 includes a housing 301, a filter 303 attached to the housing 301, a first sensor 305 arranged inside the housing 301, a second sensor 401, a device (not shown), a light bulb 309, an optical element 311, and fans 31, 32, 33, and 34. Driven by the fans 31, 32, 33, and 34, air flows in via an inlet 313 along direction Y1 and Y2 (Y2 is a circular design to increase dissipation efficiency of the light bulb 309) and passes through the light bulb 309 and the optical element 311, and then, fluxes out through an outlet 315. The filter 303 filters the air flowing into the housing 301 to assure quality of air therein. In the present example, the first sensor 305 is arranged on path of the air flow between the filter 303 and the fan 31 for measuring the temperature inside the housing 301 to obtain a first measurement value. The second sensor 401 measures the temperature outside the housing 301 to obtain a second measurement value. When a difference between the first measurement value and the second measurement value is greater than a second predetermined value, the device (not shown) transmits a signal for alerting the user to replace the filter 303. The first measurement value shows the temperature inside the housing 301, and the second measurement value shows the ambient temperature outside the housing 301. While the temperature difference between the interior space and the atmosphere outside is greater than the second predetermined value, the dissipation efficiency deteriorates because of a certain degree of flow congestion at the filter 303, and a replacement of the filter 303 is needed. As mentioned above, each critical element of the projector 400 is equipped with a mechanism for respective malfunction warning, therefore when the difference between the first measurement value and the second measurement value is greater than the first predetermined value, it means the filtration efficiency of the filter 303 is deteriorating to a certain level and a replacement of the filter 303 is required. More particularly, if other elements become invalid leading to a temperature raise, not only the device will transmit a signal 17 to the user 15, the user 15 will also receive signal indicating a corresponding failure component.

In other examples of the present application, not departing from the spirit of the present invention, and depending on the needs of the users, the location of the first sensor 105 (305) may be any position on path of the air flow inside the housing 101 (301). For instance, a location close to a heat source (such as, a light bulb or a circuit substrate). Similarly, the second sensor element 201 (401) can also be arranged at any location with representative measurement value outside the housing 101 (301).

The illustration of the embodiments of the present invention is given above for the better understanding of the characteristics and spirit of the present invention. It will be understood that the invention is not limited to the particular embodiments described herein, but is capable of various modifications and rearrangements without departing from the scope of the invention. Therefore, it is intended that the following claims, accompanied by detailed descriptions giving the broadest explanation, not only define the scope of the present invention but cover all such modifications and changes as fall within the true spirit and scope of the present invention.

What is claimed is:

1. A projector, comprising:
a housing defining an interior space;
a filter attached to said housing for filtering the air flowing into said interior space;
a first sensor arranged in said interior space for measuring the temperature therein to obtain a first measurement value; and
a device,
wherein, when said first measurement value is greater than a first predetermined value, said device transmits a signal for alerting the need of replacing said filter.

2. The projector of claim 1, wherein said first sensor is arranged at a location sensitive to the temperature variation.

3. The projector of claim 1, wherein said first sensor is arranged at a location on path of the air flow.

4. The projector of claim 1, wherein said first sensor is arranged adjacent to a light bulb within said interior space.

5. The projector of claim 1, further comprising a second sensor for measuring the temperature outside said housing to obtain a second measurement value, and said filter being located between said first sensor and said second sensor.

6. The projector of claim 5, wherein when a difference between said first measurement value and said second measurement value is greater than a second predetermined value, said device transmits a second signal for alerting the need of replacing said filter.

7. A projector, comprising:
a housing defining an interior space;
a filter attached to said housing for filtering the air flowing into said interior space;
a first sensor arranged in said interior space for measuring the temperature therein to obtain a first measurement value;
a second sensor for measuring the temperature outside said housing to obtain a second measurement value, and said filter being located between said first sensor and said second sensor; and
a device,
wherein, when a difference between said first measurement value and said second measurement value is greater than a second predetermined value, said signal device transmits a signal for alerting the need of replacing said filter.

8. The projector claim 7, wherein said first sensor is arranged at a location sensitive to the temperature variation.

9. The projector of claim 7, wherein said first sensor is arranged at a location on path of the air flow.

10. The projector of claim 7, wherein said first sensor is arranged adjacent to at a light bulb within said interior space.
